(19) United States
(12) Patent Application Publication
(10) Pub. No.: US 2006/0034647 A1
(43) Pub. Date: Feb. 16, 2006

(54) Character-information processing method, character-information processing apparatus, program, and storage medium

(75) Inventors: Makoto Takada, Shiojiri-shi (JP); Seiji Tanaka, Nagano-ken (JP); Yoichi Hine, Kashiwa-shi (JP)

Correspondence Address: HOGAN & HARTSON L.L.P., 500 S. GRAND AVENUE, SUITE 1900, LOS ANGELES, CA, 90071-2611, US

(73) Assignees: SEIKO EPSON CORPORATION; KING JIM CO., LTD

(21) Appl. No.: 11/193,755

(22) Filed: Jul. 28, 2005

(30) Foreign Application Priority Data
Aug. 11, 2004 (JP) 2004-234409

(51) Int. Cl. B41J 29/38

(52) U.S. Cl. 400/76

(57) ABSTRACT

In character-information processing, upon selectively setting a layout for printing ink characters and embossing raised letters on a common process sheet, sample images of a plurality of alternatives of layouts are displayed on a display screen of character-information processing apparatus.

### BACKGROUND OF THE INVENTION

1. Field of the Invention

This invention relates to a character-information processing method, a character-information processing apparatus, a program, and a storage medium, for printing ink characters (i.e., characters printed with ink, as compared with raised letters) and embossing raised letters (Braille or Braille points) on a common process sheet.

2. Description of the Related Art

A known process sheet (raised-letter label) serves as a common sheet (or tape) on which raised letters to be recognized by a visually handicapped person and ink characters to be visually recognized by a person without visual handicap are arranged parallel to each other (or overlapped with each other) so as to be recognized by both the visually handicapped person and the person without visual handicap. Also, a known character-information processing apparatus generates a process sheet on which ink characters are printed and raised letters are embossed so as to be arranged parallel to each other.

In such an apparatus, however, in the case of only printing ink characters, a variety of settings such as settings of a character size, a font, a decoration, and an allocation are possible in a manner similar to a general word-processor or the like. In the case of only embossing a raised letter, another variety of settings are additionally possible, thereby resulting in diversification of operations. In particular, the setting of a layout-related matter of ink characters and raised letters (especially, the relative positional relationship between these two types of character and letter) on a common process sheet does not exist in the conventional case of only printing ink characters, even when a variety of alternatives of a variety of layouts to be set are prepared. Therefore, an image of each selected alternative is difficult to be understood merely with an expression (with a written explanation) of the alternative. As a result, this necessitates an operator to refer to the necessary part of an instruction manual having a large volume because of necessary illustrations, thereby leading to a complicated and troublesome operation.

### SUMMARY OF THE INVENTION

Accordingly, it is an advantage of this invention to provide a character-information processing method, a character-information processing apparatus, a program, and a storage medium, for printing an ink character and embossing a raised letter in accordance with a desired layout by easily and effectively operating the processing apparatus without having its instruction manual or the like at hand so as to refer it.

In one aspect of this invention, there is provided a character-information processing method comprising, upon selectively setting a layout among a plurality of alternatives, displaying on a display screen, sample images of the plurality of alternatives set for printing an ink character and embossing a raised letter on a common process sheet.

In another aspect of this invention, there is provided a character-information processing apparatus for printing an ink character and embossing a raised letter on a common process sheet, comprising: layout-alternative storage means for storing a plurality of alternatives of layouts set for arranging the raised letters and ink characters on the process sheet; sample-image storage means for storing sample images of the plurality of alternatives; and display means for displaying the sample images on a display screen, upon setting a layout selected among the plurality of. alternatives.

According to the above-described character-information processing method and apparatus, upon selectively setting a layout for printing an ink character and embossing a raised letter on a common sheet, sample images of the plurality of alternatives are displayed on a display screen. Accordingly, a desired layout can be determined by easily and effectively operating the processing apparatus without having its instruction manual or the like at hand so as to refer it. In this manner, an ink character is printed and a raised letter is embossed according to the desired layout.

Preferably, the plurality of alternatives include: a parallel arrangement of ink character and raised letter for arranging the raised letter and the ink character parallel to each other; and an overlap arrangement of ink character and raised letter for overlapping at least a part of the raised letter and ink character with each other.

According to this arrangement, the plurality of alternatives include the parallel arrangement of ink character and raised letter for arranging them parallel to each other on the process sheet and the overlap arrangement of ink character and raised letter for overlapping at least a part of the same with each other on the process sheet. Hence, by simply selectively setting either one, the parallel or overlap arrangement of ink character and raised letter is set, and at the same time, a desired one is easily set after confirming it with sample images and without having its instruction manual or the like at hand so as to refer it. In this case, the parallel arrangement of ink character and raised letter includes not only an arrangement in which one type of ink character and raised letter is arranged above the other but also another arrangement in which these two types are arranged in the back-and-forth direction or in the oblique direction.

Preferably, the parallel arrangement of ink character and raised letter includes a raised-letter upper and a raised-letter lower for arranging the raised letter above and below the ink character, respectively.

According to this arrangement, the parallel arrangement of raised letter and ink character includes a raised-letter upper and a raised-letter lower for arranging the raised letter above and below the ink character, respectively. Hence, by merely selectively setting either one, the way as to whether the raised letter is to be arranged above or below the ink character is easily determined after confirming it with sample images, without having an instruction manual at hand so as to refer it.

Preferably, the method further comprises the step of displaying a preview image in place of the corresponding sample image, on the basis of set layout information after selectively setting the layout.

In the above-described apparatus, preferably, the display means displays a preview image in place of the corresponding sample image on the basis of set layout information after selectively setting the layout.

According to the above method and apparatus, the preview image is displayed on the basis of the set layout information after selectively setting the layout. Therefore, not only can confirmation be made with the sample image prior to the setting, but also can confirmation be made with the preview image after the setting has been made.

In still another aspect of this invention, there is provided a program which causes the above-described character-information processing method to be performed.

In yet another aspect of this invention, there is provided a storage medium which stores the above-described program so as to be readable with a program-processable apparatus.

The above-described program enables any of the character-information processing methods to be implemented or the character-information processing apparatus to be functioned. Hence, when the program stored in the storage medium is processed or read and executed by the program-processable apparatus, a layout is determined with an easy and effective operation of the processing apparatus without having its instruction manual or the like at hand so as to refer it. Printing of an ink character and embossing of a raised letter can thus be easily carried out.

### BRIEF DESCRIPTION OF THE DRAWINGS

FIG. 1 is an external perspective view of a label-generating apparatus according to one embodiment of this invention;

FIG. 2 is an external perspective view of the label-generating apparatus shown in FIG. 1, in a state of its lid being opened;

FIG. 3 is a general block diagram of a control system of the label-generating apparatus shown in FIG. 1;

FIGS. 4A and 4B are respectively an illustration of a six-point raised letter and a sectional view of embossing protrusions;

FIGS. 5A and 5B are respectively a plan view and a sectional view of an embossing unit;

FIG. 6 illustrates transport of a tape in a raised-letter embossing section;

FIG. 7 is a flowchart of the overall process of the label-generating apparatus;

FIGS. 8A to 8C are supplemental illustrations of process modes for the flowchart shown in FIG. 7;

FIGS. 9A to 9C are supplemental illustrations of differences in tape widths for the flowchart shown in FIG. 7;

FIGS. 10A and 10B respectively illustrate an operation and a process flow upon setting a layout;

FIGS. 11A and 11B illustrate example displays of sample images corresponding to an example selection screen shown in FIGS. 10A and 10B;

FIGS. 12A and 12B are illustrations similar to FIGS. 11A and 11B, corresponding to another selection screen shown in FIGS. 10A and 10B;

FIGS. 13A and 13B illustrate another example corresponding to the same selection screen as shown in FIGS. 11A and 11B;

FIGS. 14A and 14B illustrate another example corresponding to the same selection screen as shown in FIGS. 12A and 12B; and

FIGS. 15A and 15B illustrate example displays of preview images after setting the layout.

### DESCRIPTION OF THE PREFERRED EMBODIMENTS

A label-generating apparatus (a character-information processing apparatus) 1 according to one embodiment of this invention will be described in detail with reference to the attached drawings.

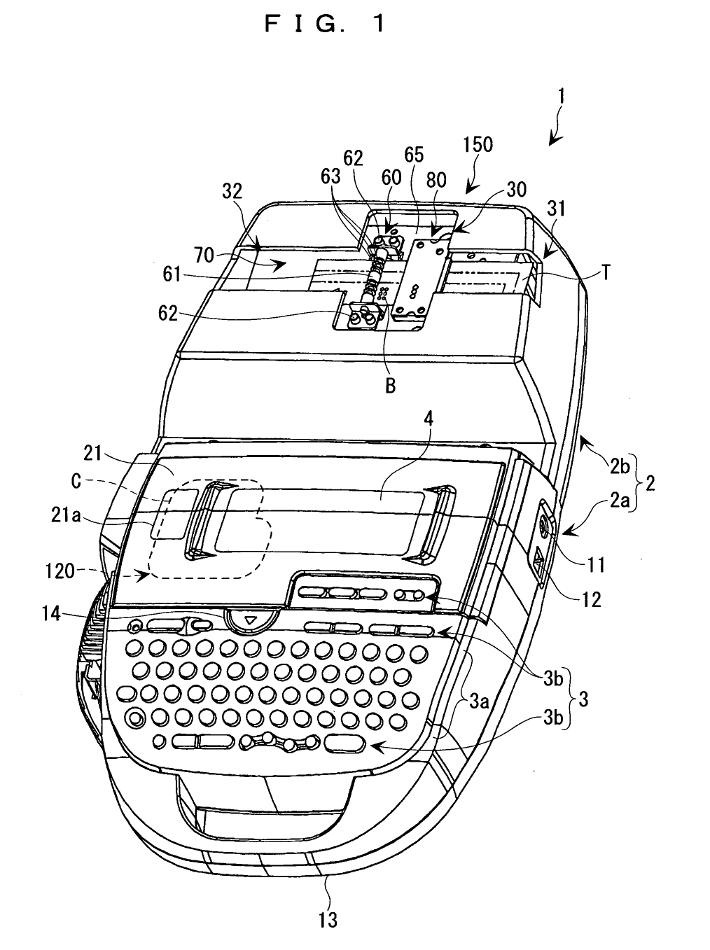

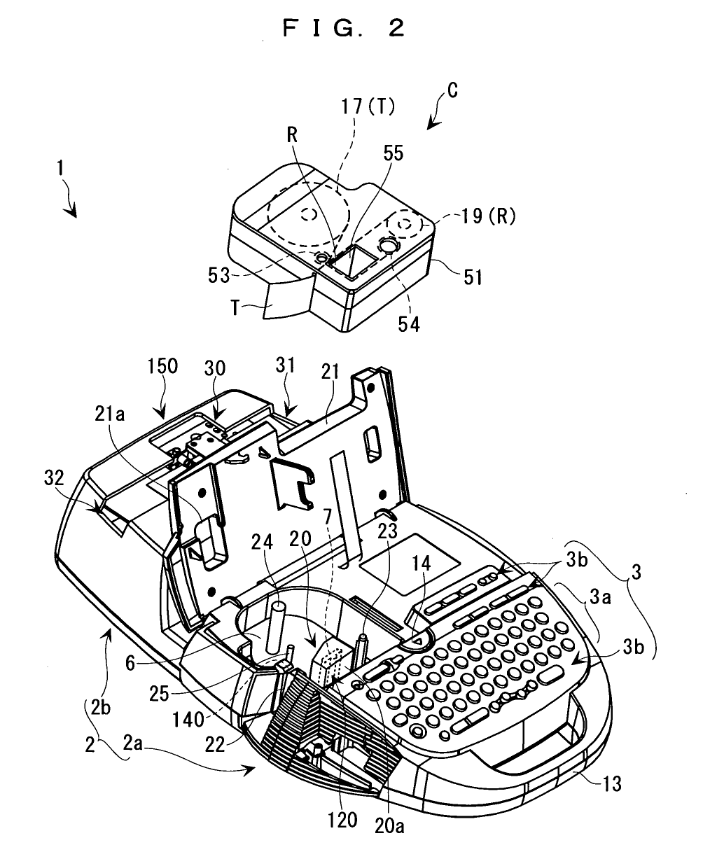

As shown in FIGS. 1 and 2, the label-generating apparatus 1 has an outer hull formed by a body casing 2 including a hand-griping portion 13. The body casing 2 has a front casing 2a and a rear casing 2b which are integrally formed together. The front casing 2a includes an ink-character printing section 120 for printing ink characters on a tape (a process sheet) T paid out from a tape cartridge C. The rear casing 2b includes a raised-letter embossing section 150 for embossing raised letters on the tape T which has printed thereon ink characters and which is to be manually inserted by an operator.

The front casing 2a has a keyboard 3 including a variety of input keys and an open-close lid 21, respectively, disposed on the front upper surface thereof and fixed to the rear upper surface thereof. The open-close lid 21 has a rectangular display 4 disposed therein and also a cartridge-mounting section 6 (the ink-character printing section 120) formed in a depressed shape on the inner left part thereof, for mounting therein the tape cartridge C. When a lid-opening button 14 is pressed down, the tape cartridge C is detachably mounted in the cartridge-mounting section 6 in an opened state of the open-close lid 21. The open-close lid 21 further has a peep hole 21a formed therein, for visually confirming the presence (mounting) or absence (non-mounting) of the tape cartridge C in a closed state thereof.

The front casing 2a has a power supply port 11 and connection port (interface) 12 formed on the right side thereof, respectively, for supplying power and for connecting the label-generating apparatus with an external apparatus such as a personal computer (not illustrated). When connected, the label-generating apparatus can print ink characters and/or emboss raised letters on the basis of character information from the external apparatus. Also, the front casing 2a has a printed-tape discharge slot 22 formed on the left side thereof so as to allow the cartridge-mounting section 6 to communicate with external equipment. The printed-tape discharge slot 22 has a cutting section 140 faced thereto, for cutting the tape T set out from the ink-character printing section 120. When the rear end of the tape T is cut by the cutting section 140, the tape T having ink characters printed thereon is discharged from the printed-tape discharge slot 22.

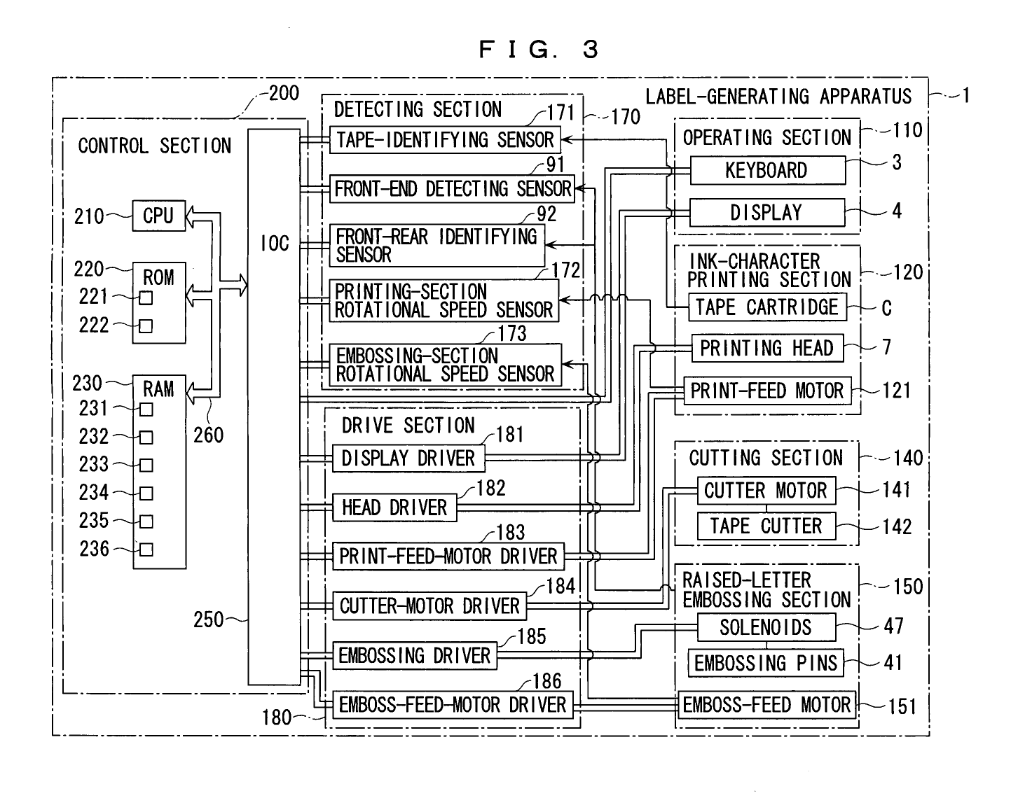

FIG. 3 is a general block diagram of the basic control system of the label-generating apparatus 1. Regarding the control system, the label-generating apparatus 1 is provided with: an operating section 110 which includes the keyboard 3 and the display 4 and which serves as a man-machine interface so as to be responsible for, for example, receiving character information and displaying a variety of information; the ink-character printing section 120 which includes the tape cartridge C, a printing head 7, and a print-feed motor 121 and which prints ink characters on the tape T while transporting the tape T and an the tape; and the cutting section 140 which includes the tape cutter 142 and a cutter motor 141 driving the tape cutter and which cuts the ink-character printed tape T.

The label-generating apparatus 1 is also provided with: the raised-letter embossing section 150 which includes solenoids 47, embossing pins 41, and an emboss-feed motor 151 and which embosses raised letters on the tape T while transporting the tape T; and a detecting section 170 which performs variety of detections and which includes a tape-identifying sensor 171 identifying the type of the tape T (the tape cartridge C), a front-end detecting sensor 91 detecting the front end of the tape T in the raised-letter embossing section 150, a front-rear identifying sensor 92 detecting a front-rear identifying mark D printed on the tape T also in the raised-letter embossing section 150, a printing-section rotational speed sensor 172 detecting a rotational speed of the print-feed motor 121, and an embossing-section rotational speed sensor 173 detecting a rotational speed of the emboss-feed motor 151.

The label-generating apparatus 1 is further provided with: a drive section 180 which performs driving of various parts and which includes a display driver 181, a head driver 182, a print-feed-motor driver 183, a cutter-motor driver 184, an embossing driver 185, and an emboss-feed-motor driver 186; and a control section 200 which is connected to the various parts to control the entire label-generating apparatus 1.

The control section 200 is provided with a CPU 210, a ROM 220, a RAM 230, and an input-output controller (hereinafter, referred to as an IOC) 250, which are connected to one another through an internal bus 260. Other than character font data for printing ink characters and raised-letter font data for embossing raised letters, the ROM 220 includes: a control program block 221 storing a control program for controlling a variety of processes such as an ink-character printing process and a raised-letter embossing process with the CPU 210; and a control data block 222 storing data for printing the front-rear identifying mark D with ink, control data for controlling embossing of raised-letter data and so forth. The character font data may be stored in an independently disposed character generator ROM (CG-ROM) instead of being stored in the ROM 220.

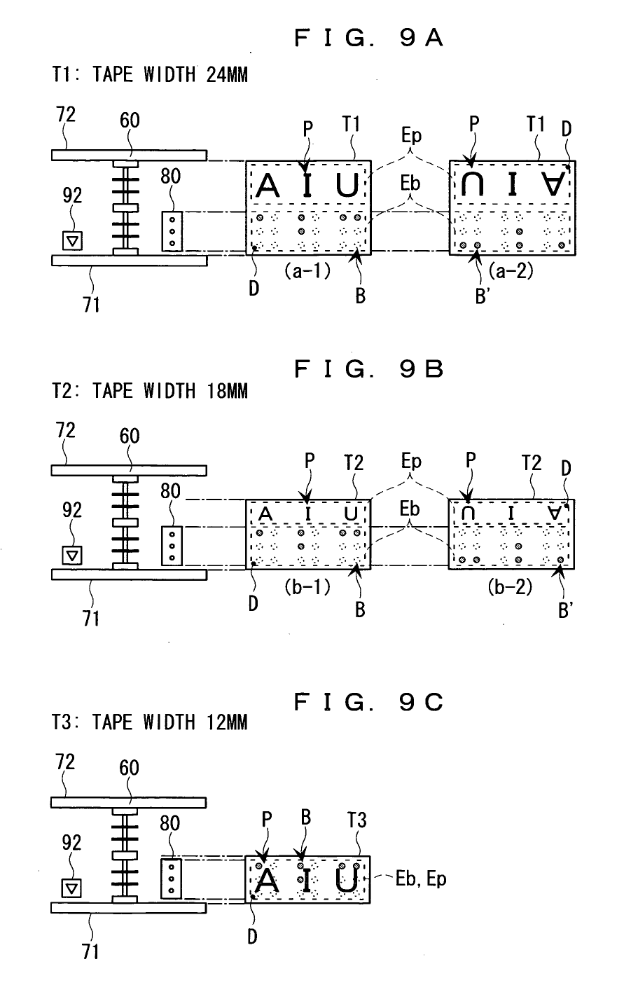

Other than a variety of work-area blocks 231 used as flags and so forth, the RAM 230 is used as a working area for process control of the apparatus and includes: an ink-character printing data-block 232 storing generated ink-character printing data; a raised-letter embossing data-block 233 storing generated raised-letter embossing data; a display data-block 234 storing display data for being displayed on the display 4; a layout block 235 storing a layout of a set ink-character printing area (a print-arranging section) Ep and a set raised-letter embossing area (an emboss-arranging section) Eb; and a reversed raised-letter data block 236 storing reversed raised-letter data B′ (see FIGS. 9A and 9B) for use in the case where raised letters are embossed in a state of being turned by 180 degrees (i.e., in the form of upside down) in accordance with a set layout. The RAM 230 is always backed up by a battery, for holding the stored data even when the power is shut down.

The IOC 250 has logic circuits integrated therein, each formed by a gate array or a custom LSI, for compensating for a function of the CPU 210 and also handling interface signals with a variety of peripheral circuits. With this structure, the IOC 250 incorporates input data or control data from the keyboard 3 or a variety of sensor values of the detecting section 170 into the internal bus 260 with or without being processed, and, at the same time, outputs data and a control signal, which are outputted from the CPU 210 to the internal bus 260, to the drive section 180 in conjunction with the CPU 210 with or without being processed.

With the above-described structure, in accordance with the control program in the ROM 220, the CPU 210 receives a variety of signals and data from the various parts in the label-generating apparatus 1 through the IOC 250, processes a variety of data in the RAM 230 on the basis of the variety of received signals and data, and outputs the variety of signals and data to the various parts in the label-generating apparatus 1 through the IOC 250, so as to control an ink-character printing process, a raised-letter embossing process, and so forth.

For example, upon receiving character information from the keyboard 3, the CPU 210 generates ink-character printing data P and raised-letter embossing data B on the basis of this information, adjusts, for example, the lengths of the two pieces of data if needed, and prepares reversed raised-letter data B′ (see FIGS. 9A and 9B). Also, the CPU 21 stores the prior or post adjustment ink-character data (including margin data) P and raised-letter data (including margin data) B, respectively, in the ink-character printing-dada block 232 and the raised-letter embossing data-block 233, in addition to storing the reversed raised-letter data B′ in the reversed raised-letter data block 236.

Also, upon receiving an instruction for printing ink characters and embossing raised letters from the keyboard 3, by starting drive of the print-feed motor 121 and driving the printing head 7 in accordance with a rotational speed detected by the printing-section rotational speed sensor 172, ink characters are printed on the basis of ink-character printing data P and at the same time, also a front-rear identifying mark D of an inserting tape is printed on the basis of the ink-character printing data P and previously stored data in the control data block 222. Then, on the basis of the ink-character printing data (adjusted if needed), the tape T having a predetermined length is fed, the rear end of which is cut with the tape cutter 142, and is discharged through the printed-tape discharge slot 22.

As shown in FIGS. 1 to 3, subsequently, when the tape T cut in a strip-shaped pattern is manually inserted into an embossing-tape insert slot 31 by the operator in a state in which a reset operation and a power-off operation are not performed, by driving an embossing unit 80 and a tape-feeding mechanism 60, a raised letter is embossed on the basis of the raised-letter embossing data B or the reversed raised-letter data B′. After completion of embossing, the tape T having a predetermined length and already adjusted on the basis of the raised-letter embossing data B and so forth is fed by driving the emboss-feed motor 151 and discharged through an embossed-tape discharge slot 32. Meanwhile, an embossing operation with the embossing unit 80 can be manually started by the operator by pressing down an embossing key arranged on the keyboard 3 in place of detecting the front end of the tape as a trigger, with the front-end detecting sensor 91.

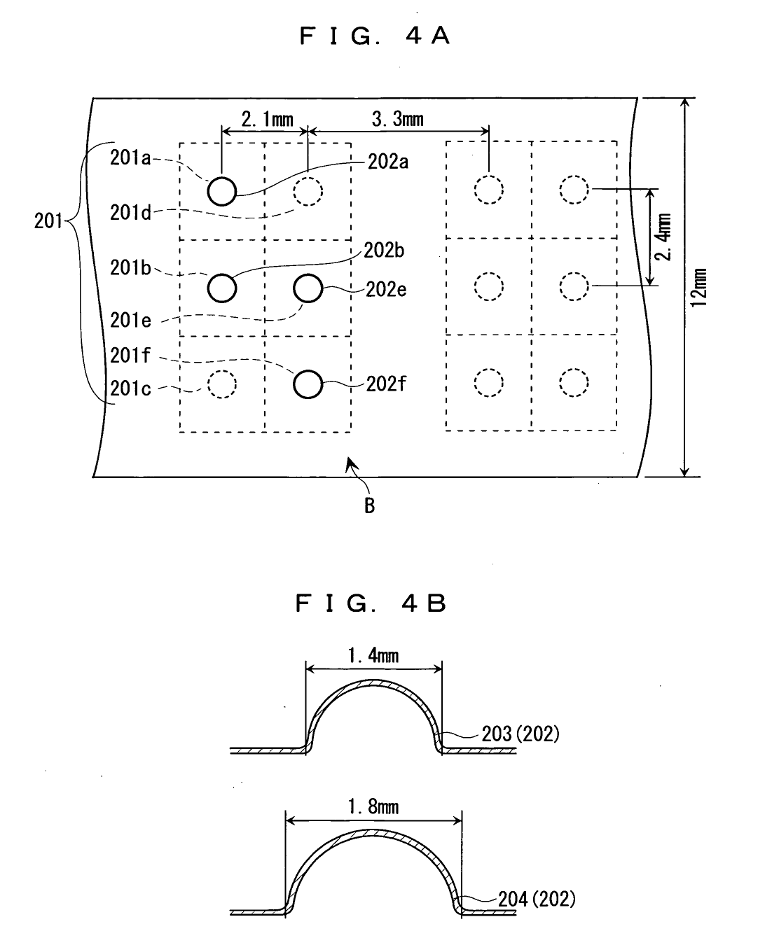

Referring now to FIGS. 4A and 4B, a raised letter B (a six-point raised letter B) to be formed on the tape T will be described.

According to the commercially available specifications of a single character (a single cell) and a character spacing (a cell spacing) customarily applied to a raised-letter writing device, a type writer, and the like, as shown in the figure, the six-point raised letter B has a single cell 201 made up of six points of three points high by two points wide (six embossing points consisting of so-called first to sixth points), and its attributes such as a single character and a dot mark are expressed by patterns formed by embossing- and non-embossing points of the six points constituting the single cell 201. For example, FIG. 4A illustrates the raised letter (Braille point) B representing Japanese character information “shi” formed by arranging the first, second, fifth, and sixth points to be embossing points and the third and fourth points to be non-embossing points 1.

Other than the six-point raised letter B for representing a Japanese “kana” character or a numerical character, an eight-point raised letter B (having a single cell 1 including eight points made up of four points high by two points wide) is also used for representing a Japanese “kanji” character. While the label generating apparatus according to this embodiment forms the six-point raised letter B by way of example, this invention is also applicable to that forming an eight-point character.

The single cell 201 of the six-point raised letter B has an arrangement pattern of three points high by two points wide and is divided into six embossing points 201a to 201f. The vertical and the horizontal pitches of the six embossing points within the cell are respectively about 2.4 mm and about 2.1 mm, and the pitch between the cells is about 3.3 mm. In the figures, in order to represent a Japanese kana character “shi”, the four embossing points 201a, 201b, 201e, and 201f of the six embossing points 201a to 201f are selectively embossed, and four embossing protrusions 202a, 202b , 202e, and 202f, each having a rounded sectional shape (see FIG. 4B) such as a cylindrical, semi-sphere, conical, or quadrangular pyramid shape, are thus formed on the tape T. In order to emboss the six-point raised letter B, the tape (T3) having at least a width of 12 mm is needed, taking the size (the length in the tape width direction) of the single cell 201 into consideration.

As the embossing units 80 of the label-generating apparatus 1 according to this embodiment, two types of mutually changeable ones are prepared: one is a small-sized embossing protrusion 203 having a diameter of about 1.4 mm, and the other is a large-sized embossing protrusion 204 having a diameter of about 1.8 mm. The two types of large and small embossing protrusions 203 and 204 are selectively used in accordance with their respective applications. For example, the small embossing protrusion 203 is intended for a person (a congenital blind person) accustomed to reading the raised letters B, and the large embossing protrusion 204 is intended for a beginner (a non-congenital blind person).

Referring back to FIGS. 1 to 3, the label generating apparatus 1 will be further described in detail. The keyboard 3 has a character key group 3a and a function key group 3b both arranged thereon, for instructing a variety of operational modes and the like. The character key group 3a is used for inputting character information for printing ink characters and embossing raised letters and has a full key structure in accordance with Japanese Industrial standards (JIS) arrangement. Other than a print-execution key (a print key) for executing printing of ink characters and/or embossing of raised letters, a tape-feed start key for instructing start of feeding the tape T in the raised-letter embossing section 150, and an emboss start key for manually embossing raised letters, the function key group 3b includes a mode key for selecting one of process modes for printing ink characters and embossing raised letters; a layout key for setting a layout of the ink-character printing area (the print-arranging section) Ep and the raised-letter embossing area (the emboss-character arranging-section) Eb; and a scroll key for displaying the set layout result in a scrolling manner, for example, before execution of printing the set arrangement. In addition to these keys, in the same manner as in a typical word-processor or the like, the function key group 3b includes a cancel key for, for example, canceling a process, a cursor key for moving a cursor; and an enter key for determining one of a variety of alternatives and for feeding a line upon entering an text, and so forth.

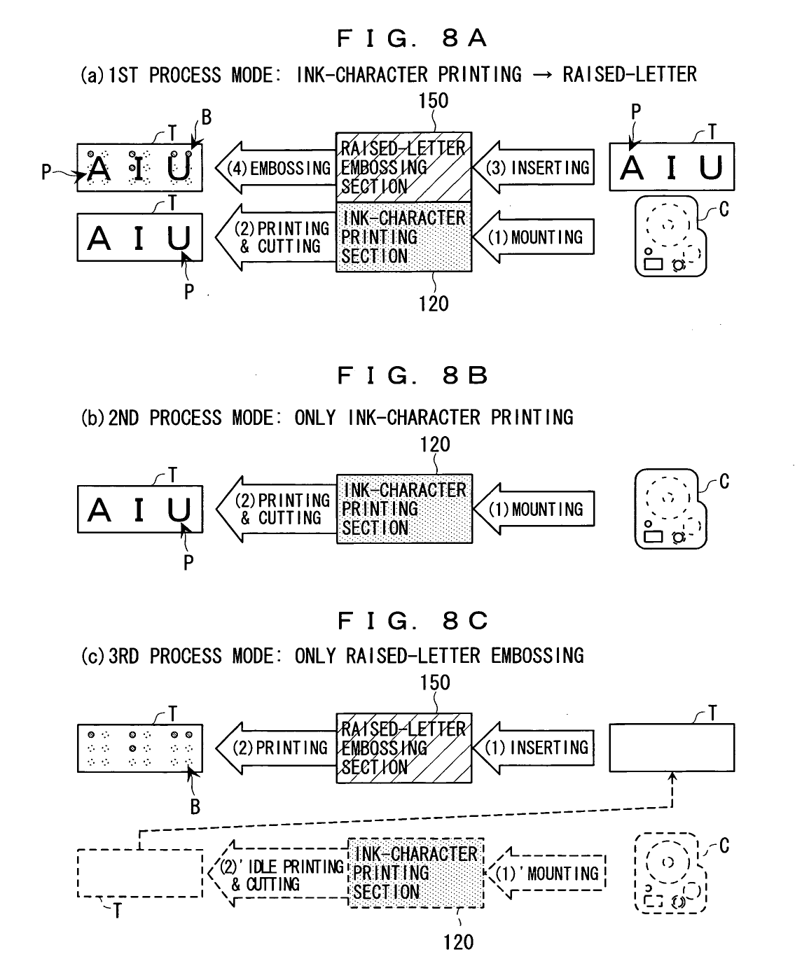

The process modes selected by the mode key includes a first process mode (see FIG. 8A, three Japanese kana characters “A”, “I”, “U” appearing in the figure) for printing ink characters and embossing raised letters, a second process mode (see FIG. 8B, three Japanese kana characters “A”, “I”, “U” appearing in the figure) for only printing ink characters, and a third process mode (see FIG. 8C) for only embossing raised letters, all on the basis of inputted character information, and any one of the process modes is selected.

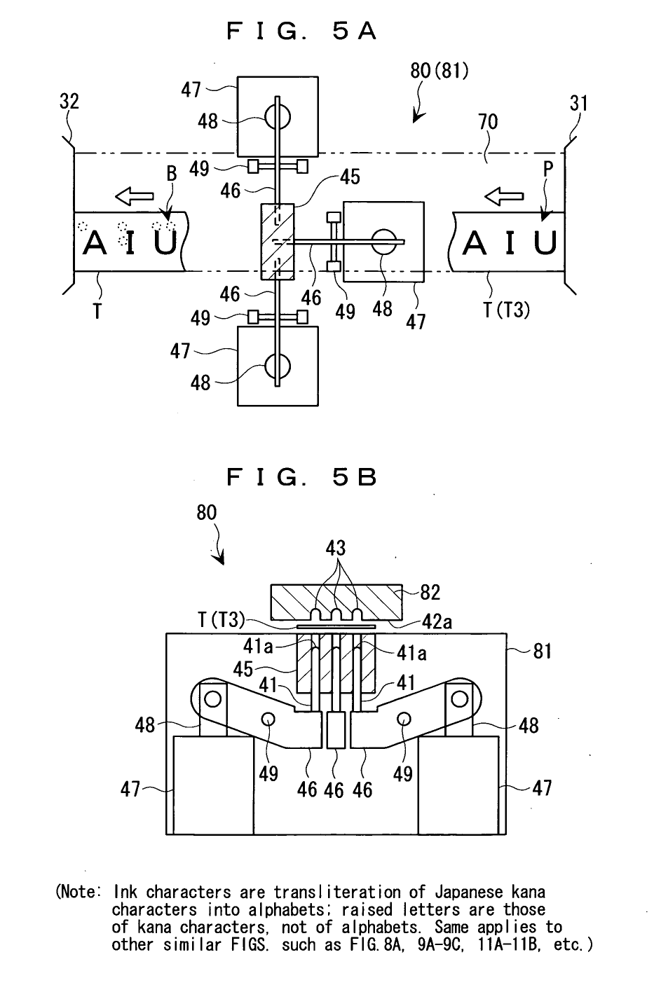

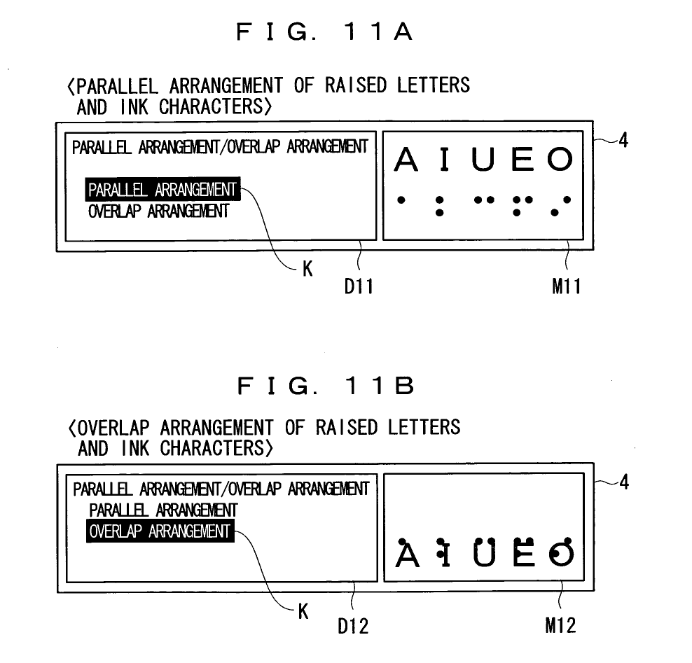

It is to be noted that, in the illustrated examples, ink characters in FIGS. 5A, 8A, etc. as well as in FIGS. 11A, 11B through 15A, 15B are transliterations of Japanese kana characters “A”, “I”, “U” as well as “A”, “I”, “U”, “E”, “O”, respectively, into corresponding alphabets, but that the raised letters are those of Japanese kana characters, not of alphabets.

The display 4 is capable of displaying an image formed by 192 dots by 80 dots within a rectangle extending horizontally (in the X-direction) by about 12 cm and vertically (in the Y-direction) by 5 cm. The display 4 is used when the operator inputs character information with the keyboard 3 so as to generate and edit ink-character printing data and/or raised-letter embossing data, and displays a variety of errors and messages (instructions) so as to notify the operator of the errors and messages.

The ink-character printing section 120 includes the following components in the cartridge-mounting section 6: i.e., a head unit 20 having the printing head 7 composed of a thermal head, built in a head cover 20a thereof; a platen-driving shaft 25 facing the printing head 7; a take-up driving shaft 23 for taking up an ink ribbon R; and a positioning projection 24 for positioning a tape reel 17, in addition to having the print-feed motor 121 built therein under the cartridge-mounting section 6, for rotating the platen-driving shaft 25 and the take-up driving shaft 23.

The tape cartridge C includes a cartridge casing 51 having the tape reel 17 and a ribbon reel 19 accommodated therein. The tape T and the ink ribbon R are formed so as to have a common width. Also, the tape cartridge C has a through-hole 55 perforated therein so as to be inserted into the head cover 20a and a platen roller 53 which is disposed so as to correspond to a portion where the tape T and the ink ribbon R overlap with each other and which is driven for rotation while being engaged with the platen-driving shaft 25. The ink ribbon R paid out from the ribbon reel 19 is taken up by a ribbon take-up reel 54 disposed next to the ribbon reel 19, after turning around the head cover 20a.

When the tape cartridge C is mounted in the cartridge-mounting section 6, the head cover 20a, the positioning projection 24, the platen-driving shaft 25, and the take-up driving shaft 23 are respectively inserted into the through-hole 55, the center bore of the tape reel 17, the platen roller 53, and the center bore of the ribbon take-up reel 54. Thus, the printing head 7 is abutted against the platen roller 53, having the tape T and the ink ribbon R interposed therebetween, so as to print ink characters. The ink-character printed tape T is fed to the printed-tape discharge slot 22.

Although not illustrated in the figures, the tape T includes a base sheet (an information-producing layer) having an adhesive layer disposed on the rear surface thereof and a sheet of releasing paper (a releasing paper layer) bonded to the backing sheet with the adhesive layer. The backing sheet includes an image-receiving layer having an improved feature of fixing ink thermally transferred from the ink ribbon and a film composed of polyethylene terephthalate (PET) in order from the upper surface thereof and is formed by depositing a backing layer serving as the main part of the backing sheet and the adhesive layer including an adhesive.

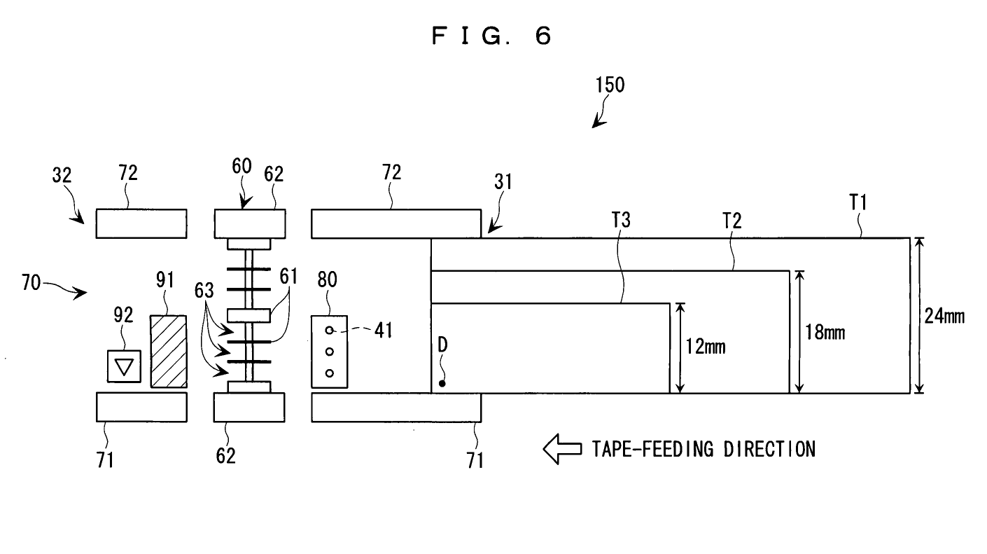

The tapes T have a plurality of prepared tape types with respect to a tape width, a tape color, an ink-character color, a tape material, and the like, and a plurality of bores (not illustrated) indicating the corresponding type is perforated in the rear surface of the cartridge casing 51. Since the cartridge-mounting section 6 has a plurality of the tape-identifying sensors (micro switches) 171 disposed therein, corresponding to the plurality of bores so as to detect these bores, by detecting the states of the tape-identifying sensors 171, a tape type can be identified. In this embodiment, three types of tapes T1, T2, and T3 respectively having tape widths of 24 mm, 18 mm, and 12 mm are used by way of example (see FIG. 6).

The rear casing 2b has an assembly (the raised-letter embossing section 150) incorporated therein, for embossing raised letters, and its upper surface is opened in a cross-shaped pattern (that is, a cutaway opening) 30 so as to allow the raised-letter embossing section 150 (to be specific, a tape-traveling path 70, the embossing unit 80, and the tape-feeding mechanism 60) to be exposed. The cutaway opening 30 has the embossing-tape insert slot 31 formed at the right part thereof, for the tape T to be manually inserted therethrough by the operator, and the embossed-tape discharge slot 32 formed at the left part thereof, for the raised-letter embossed tape T to be discharged therethrough.

The raised-letter embossing section 150 includes the embossing unit 80 embossing raised letters with three embossing pins 41 (see FIG. 5B); the tape-feeding mechanism 60 feeding the tape T inserted into the embossing-tape insert slot 31 towards the embossed-tape discharge slot 32; and the tape-traveling path 70 for the tape T to be transported 70 thereon. With this structure, by selectively driving the three embossing pins 41 with the embossing unit 80, the raised letters B are formed on the tape T which is being fed along the tape-traveling path 70 by driving the tape-feeding mechanism 60.

As shown in FIG. 5B, the embossing unit 80 includes an embossing member (an embossing head) 81 disposed on the rear side of the tape T and having the three embossing pins 41 incorporated therein; and an emboss-receiving member 82 receiving the embossing pins 41 at a position facing the embossing member 81, having the tape T interposed therebetween, and is fixed at the bottom of the figure with respect to the width direction of the tape-traveling path 70.

The embossing member 81 includes the three embossing pins 41 which are arranged at an interval of 2.4 mm along the tape width direction (along the vertical direction in FIG. 5A), and which correspond to the vertically arranged three embossing points 201a to 201c (or 201d to 201f) of the six embossing points. They are held by a guide member 45 guiding straight movements of these pins with the aid of solenoids 47 as driving sources so as to be orthogonal to the tape T. Each embossing pin 41 has a head 41a formed such that each embossing protrusion 202 has a rounded sectional shape (see FIG. 4B) such as a cylindrical, semi-sphere, conical, or quadrangular pyramid shape. When a plunger 48 is straightly moved by the corresponding solenoid 47, an arm member 46 is turned about a support member 49 as a fulcrum, whereby the corresponding embossing pin 41 moves straightly in a direction orthogonal to the tape T. The three solenoids 47 connected to the corresponding three arm members 46 are arranged so as to be located at respective corners of a triangle formed by these solenoids. The emboss-receiving member 82 has three emboss-receiving depressions 43 formed on a surface 42a thereof, facing the three embossing pins 41, so as to correspond to the three embossing pins 41. Thus, the embossing protrusions 202 are formed on the tape T by the embossing pins 41 and the emboss-receiving member 82.

As shown in FIG. 6, the raised-letter embossing section 150 further includes: guide members 71 and 72 guiding the tape T so as to be properly transported; the transmissive front-end detecting sensor 91 detecting the front end of the tape T; and the reflective front-rear identifying sensor 92 (detecting sensor) detecting the front-rear identifying mark D for identifying the front and rear of the tape T. As shown in the figure, a dot mark is printed in the vicinity of the front end of the tape T and the bottom of the figure so as to serve as the front-rear identifying mark D, and this mark indicates an inserted direction (the front side) of the tape.

While the tapes T1, T2, and T3 in decreasing order of width, respectively, having tape widths of 24, 18, and 12 mm, can be inserted into the embossing-tape insert slot 31, the tape T1 having the maximum tape width is guided by the upper and lower guide members 71 and 72, and each of the other tapes T2 and T3 is guided only by the lower guide members 71. Each guided tape is manually inserted by the operator until its front end reaches the tape-feeding mechanism 60 (feed rollers 61) (at a position in which the tape can be inserted). Then, upon pressing down the tape-feeding start key on the keyboard 3, the tape starts to be fed with the tape-feeding mechanism 60.

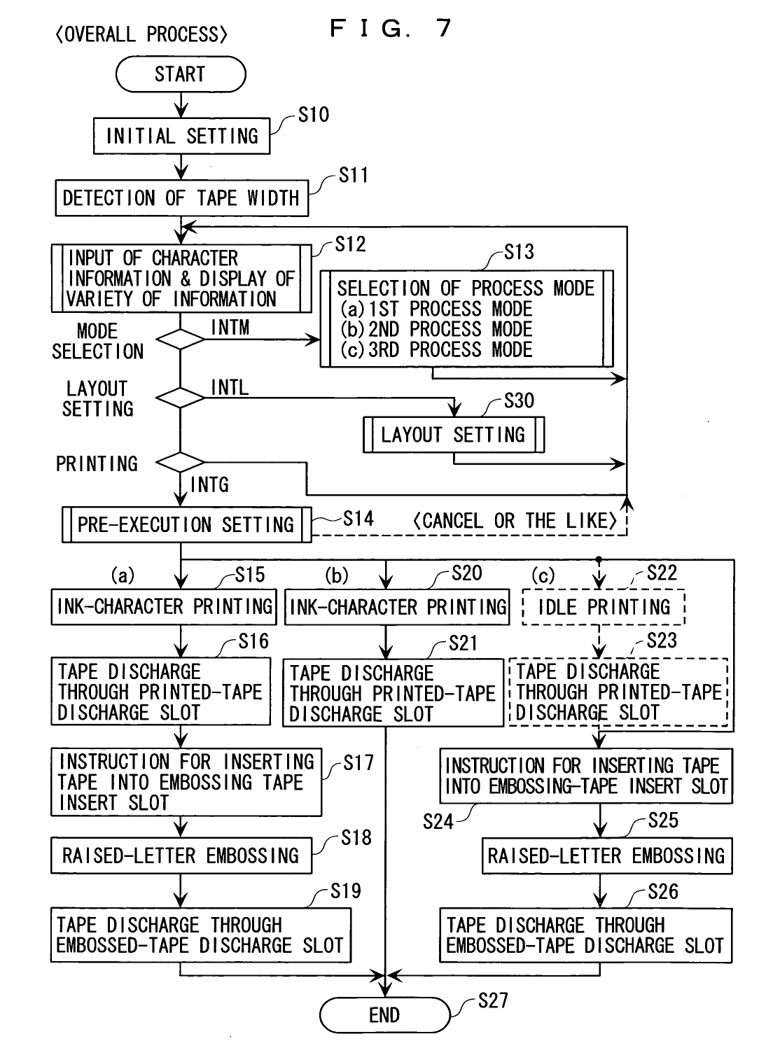

Referring next to FIGS. 7 to 9A-9B, the overall process of the label-generating apparatus 1 will be described. As shown in FIG. 7, upon start of the process by pressing down a power key (for power-on), initialization of the process including restoring various saved control flags is first made (step S10) in order to recover the previous power-off state and a type of the tape is detected by the tape-identifying sensors 171 (see FIG. 3) (step S11). Subsequently, character information is inputted in accordance with data inputted by the operator from the keyboard (or from an external apparatus such as a personal computer), and a variety of information serving as editing screens and so froth are displayed (step S12).

On this occasion, when a mode-selection interruption (INTM) occurs in response to a mode-selection instruction (a mode-key input) from the keyboard 3, a process-mode selecting process is started up, and any one of a first process mode (for a parallel arrangement of raised letters and ink characters), a second process mode (for an arrangement of only ink characters), and a third process mode (for an arrangement of only raised letters) is selected (step S13).

When a layout-setting interruption (INTL) occurs in response to a layout-setting instruction (an input from the layout key) (or an instruction input from the external apparatus), a layout setting is started up (step S30). When a print interruption (INTG) occurs in response to a print-execution instruction (a print-key input) (or in response to an instruction input from the external apparatus), a pre-execution setting-process is started up (step S14).

In the pre-execution setting-process (step S14), settings such as an allocation arrangement and a final confirmation of a variety of settings necessary for actually printing of ink characters and embossing of raised letters is carried out. When a print interruption occurs (INTG) occurs without a mode-selection interruption or a layout-setting interruption, the process is regarded as a default and the previous setting mode (at the initial setting, the first process mode, i.e., a raised-letter lower and a parallel arrangement of raised letters and ink characters) is selected. Upon completion of the pre-execution setting-process (step S14), a process for actually printing ink characters and embossing raised letters is started.

More particularly, as shown in FIGS. 7 and 8A, in the case of the first process mode ((a) in step S13), ink-characters P are printed (printing of ink characters is performed) with the ink-character printing section 120 (step S15), the tape T is then discharged through the printed-tape discharge slot 22 (step S16), and an instruction for inserting the tape T into the embossing-tape insert slot 31 is displayed on the display 4 (step S17). The above-described instruction may be displayed with an indicator or an LED instead of the display.

When the tape T is manually inserted into the embossing-tape insert slot 31 by the operator in accordance with a tape-insert instruction, the raised letters B are embossed (embossing of raised letters is performed) (step S18) with the raised-letter embossing section 150, the embossed tape T is then discharged through the embossed-tape discharge slot 32 (step S19), and the process ends (step S27). In this case, in the raised-letter embossing section 150, the front-rear identifying mark D is detected. When the detected insert direction of the tape is different from that in which the raised letters are to be embossed in accordance with the set layout, the raised letters are not embossed.

In the case of the second process mode ((b) in step S13), ink characters are printed with the ink-character printing section 120 (step S20), the tape T is then discharged through the printed-tape discharge slot 22 (step S21), and the process ends (step S27). Namely, in the second process mode, as shown in FIG. 8B, the tape T paid out from the corresponding mounted tape cartridge C is fed to the ink-character printing section 120 for ink characters P to be printed thereon. In the case where the second process mode is selected, printing of the front-rear identifying mark D can be omitted.

In the case of the third process mode ((c) in step S13), an instruction for inserting the tape T into the embossing-tape insert slot 31 is displayed on the display 4 (step S24), raised letters are embossed on the tape T inserted by the operator (step S25), the embossed tape T is then discharged through the embossed-tape discharge slot 32 (step S26), and process ends (step S27). In other words, in the third process mode, as shown in FIG. 8C, the strip-shaped tape (the tape cut in an arbitrary length) T is manually fed to the raised-letter embossing section 150, and the raised letters B are embossed on the tape T. Likewise, in this case, in the raised-letter embossing section 150, when the detected insert direction of the tape is different from that in which the raised letters are to be embossed in accordance with the set layout, the raised letters are not embossed.

Likewise, in the case of the third process mode, since the detecting operation of the front-rear identifying mark D can be omitted, whether the front-rear identifying mark D is detected or not may be selected. Also, in order to obtain a strip-shaped manually inserting tape T, as shown by dotted lines, the third process may be arranged such that, prior to an instruction for inserting the tape (step S24), an idle printing operation (only feeding the tape without printing) is performed instead of printing an ink character in the first process mode (step S22), the tape T is discharged through the printed-tape discharge slot 22 (step S23) and cut so as to serve as the strip-shaped manually inserting tape T. Also, the tape cartridge C can be placed upstream of the raised-letter embossing section 150 so as to emboss raised letters on a long tape paid out from the tape cartridge C. Further, printing of ink characters and embossing of raised letters can be performed on the basis of mutually different character information in place of the common one.

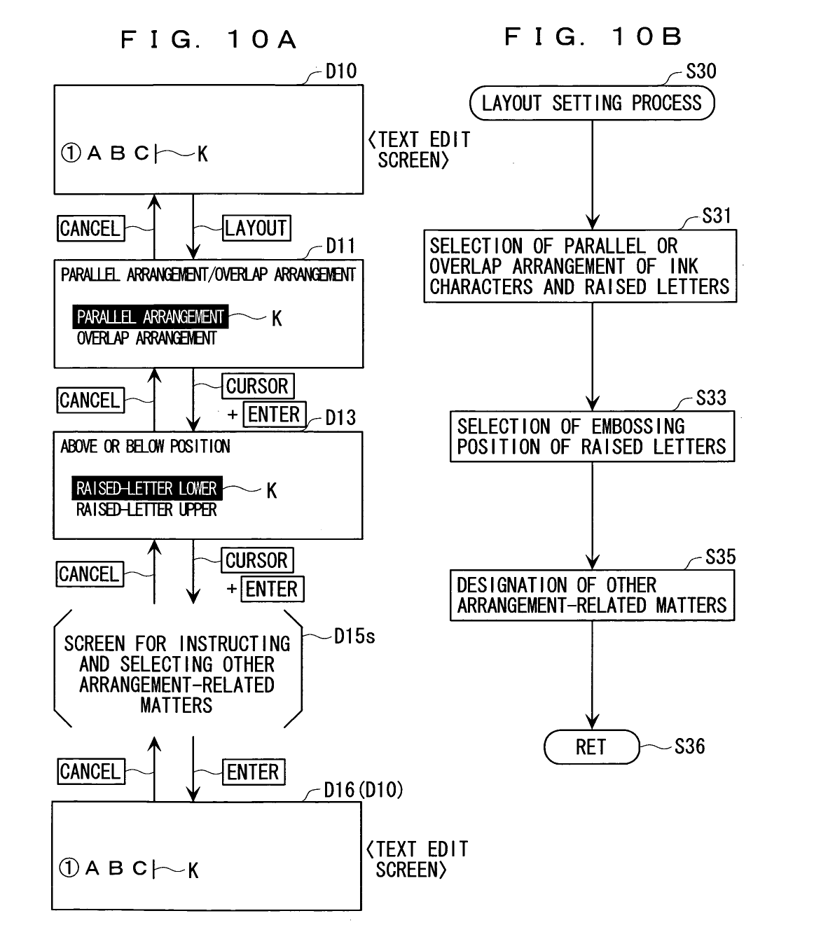

In the step of layout setting (step S30), on the basis of the detected tape width (step S11) and the selected process mode (step S13), the relative locations of the ink-character printing area (the print-arranging section) Ep and the raised-letter embossing area (the emboss-arranging section) Eb on the tape T (see FIG. 9A and others) and dimensions of each arranging section (a print-character arranging-section length PL, an emboss-letter arranging-section length BL, a common arranging-section length CL (the longer one between PL and BL, and the like), and so forth are set in the main. In addition, general settings such as setting the size of printed ink characters are performed in the same manner as in the tape printing apparatus, a word processor, and the like (see step S35 in FIG. 10B and the like).

Especially, in the case of the first process mode (for the parallel arrangement of raised letters and ink characters), a layout is selected as shown in FIGS. 9A-9C. More particularly, in the case of the detected tape width of 24 mm (i.e., the tape T1) (see FIG. 9A), either one of the following two arrangements is selected: the one in which the print-arranging section Ep is allocated on the upper row of the tape and the emboss-arranging section Eb is allocated on the lower row of the tape (indicated by (a-1) in FIG. 9A, hereinafter, referred to as “raised-letter lower row” or “raised-letter lower”) and the other in which the print-arranging section Ep is allocated on the lower row of the tape and the emboss-arranging section Eb is allocated on the upper row of the tape (indicated by (a-2), hereinafter, referred to as “raised-letter upper row” or “raised-letter upper”. The terms used here “upper” and “lower” of the tape T are defined when the front-rear identifying mark D is set in the tape-inserting direction (in the leftward direction) and the upper surface of the tape is set so as to serve as an information-forming section.

In the case of the tape width of 18 mm (i.e., the tape T2) (see FIG. 9B), while either the raised-letter lower row or upper row (respectively indicated by (b-1) and (b-2)) is likewise selected, in this case, the length of the print-arranging section Ep in the tape width direction becomes shorter in accordance with the tape width. In the case of the tape T1 or T2, aside from a layout of arranging ink characters and raised letters parallel to each other (hereinafter, referred to as a “parallel arrangement of ink characters and raised letters” or simply referred to as a “parallel arrangement”), there can be selected another layout of overlapping ink character and raised letter with each other (hereinafter, referred to as an “overlap arrangement of raised letters and ink characters” or simply referred to an “overlap arrangement”).

In the case of the tape width of 12 mm (i.e., the tape T3) (see FIG. 9C), since the tape width is minimum for embossing raised letters having a size (the length in the width direction) of the single cell 201 (see FIG. 4A), regardless of a selection between the raised-letter upper row and lower row (between the raised-letter upper and the raised-letter lower) and also regardless of a selection and a setting between the parallel arrangement and overlap arrangements of ink character and raised letter (i.e., between the parallel and overlap arrangements, see FIGS. 10A, 10B), only a layout of overlapping the print-arranging section Ep and the emboss-arranging section Eb with each other is available.

A typical operation performed on the display 4 upon generating a label, in accordance with an input by the operator from the keyboard 3, especially an example operation of the above-described layout setting (step S30) will be described in detail.

In the label-generating apparatus 1, other than typical display screens such as a text edit screen (hereinafter, referred to as “typical display screens”), an image display screen (hereinafter, referred to as a “monitor screen”) for displaying an image can be displayed within the display 4 (see FIGS. 11A-11B through FIGS. 14A-14B). Hence, regarding a variety of selection screens as described below, sample images, each showing an image of printed ink characters and embossed raised letters in the case where an alternative selected (designated by a cursor) is determined as that meeting a selection requirement at that moment, are displayed on the monitor screen within the display 4.

For example, as shown in FIG. 10A, in a state of displaying a text edit screen on which a character array “ABC” is inputted up to a cursor K on a first line (D10 or a state of screen D10) (hereinafter, a state of a typical display screen of the display 4 is represented by screen Dxx and only Dxx is used in the following descriptions and the drawings), when the layout key is pressed down by the operator (corresponding to the layout-setting interruption (INTL) shown in FIG. 7), the monitor screen is scrolled to a layout setting screen (D11) for processing the layout setting (step S30).

In other words, the monitor screen is scrolled to a parallel or overlap selection screen (D11) serving as the first setting screen, for selecting either the parallel or overlap arrangement of ink characters and raised letters (step S31). On this screen, either the parallel arrangement for arranging ink characters and raised letters parallel to each other or the overlap arrangement for overlapping ink characters and raised letters with each other can be selected and designated with an operation of the cursor (meanwhile, in the immediate aftermath of scroll of the monitor screen, the previously designated alternative is displayed as a default with cursor designation, and, at the initial setting, the parallel arrangement is set). Likewise, with respect to a variety of selection screens as described below, likewise, in the immediate aftermath of scroll of the monitor screen, the previously designated alternative is basically displayed as a default with designation of the cursor, its description is omitted, and only the initial setting is described if needed.

As shown in FIG. 11A, in a state in which the above-described “parallel arrangement” is designated with the cursor, (hereinafter, this state is simply referred to as a “designated state”) (D11), a sample image previously prepared so as to correspond to this arrangement and showing an image of the parallel arrangement is displayed on a monitor screen M11 (screen M11; hereinafter, a state of the monitor screen is represented by Mxx and only Mxx is used in the following descriptions and drawings). As shown in FIG. 11B, when the screen is scrolled from this state (D11) to a designated state of the overlap arrangement (D12) with an operation of the cursor, a sample image previously prepared so as to correspond to this arrangement and showing an image of the overlap arrangement is displayed (M12).

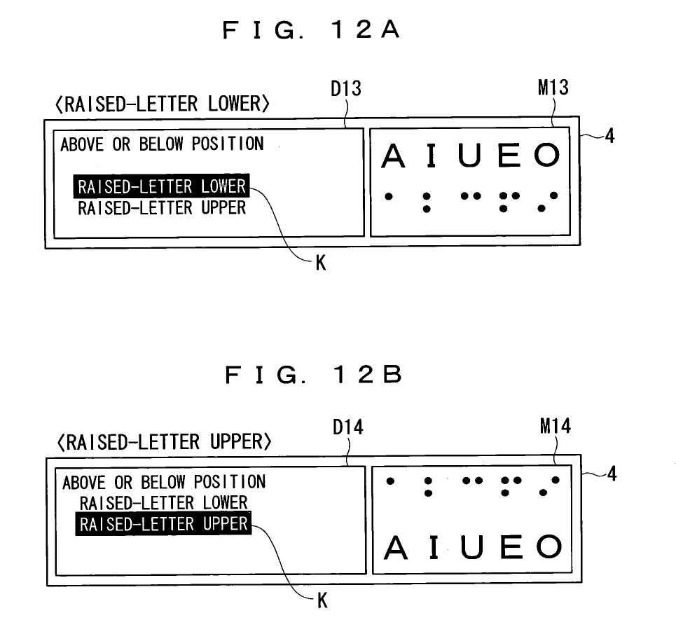

Referring back to FIG. 10A, when the parallel arrangement is then designated (selected) from the above-described state (D11) with the cursor and is determined by pressing down an enter key (hereinafter, simply referred to as a “selection & determination is made”), the parallel arrangement (parallel arrangement of ink characters and raised letters) is set as a method of arranging ink characters and raised letters. Subsequently, as shown in FIGS. 10A-10B and 12A-12B, the monitor screen is transferred to a setting screen (D13) of a raised-letter embossing position (an above or below position) for selecting a raised-letter embossing position (step S33).

On this setting screen, either the raised-letter lower (raised-letter lower row; see FIG. 12A and (a-1) and (b-1) shown in FIG. 9A) for arranging raised letters on the lower row (below the ink characters as seen in the normal up-and-down direction of the label) or the raised-letter upper (raised-letter upper row; see FIG. 12B and (a-2) and (b-2) shown in FIG. 9A) for arranging raised letters on the upper row (above the ink characters as seen in the normal up-and-down direction of the label) can be selected and designated with the operation of the cursor while referring to and confirming the corresponding sample images (M13 and M14) (meanwhile, at the initial setting, the raised-letter lower (raised-letter on the lower row) is set).

Referring again to FIG. 10A, when the raised-letter lower is selected and determined from the above-described state (D13), the raised-letter lower (the raised-letter on the lower row) is set as a method of arranging ink characters and raised letters. Subsequently, in order to designate a variety of other settings of arrangement-related matters (step S35), the monitor screen is scrolled to a screen for selecting and designating a variety of arrangement-related matters (D15s), and upon completion of this step, the process returns to the text edit screen (in a state of receiving character information) (D16: same as D10, corresponding to step S12 in FIG. 7).

As described above in detail, in the label-generating apparatus 1 according to this embodiment, upon selecting and setting a layout of ink characters and raised letters to be arranged on the tape T (a common process sheet) among a plurality of alternatives, sample images of the plurality of alternatives are displayed on the monitor screen (the display screen). Hence a desired layout can be determined by easily and effectively operating the processing apparatus without having its instruction manual or the like at hand so as to refer it. The printing of ink characters and embossing of the raised letters can thus be performed according to the desired layout.

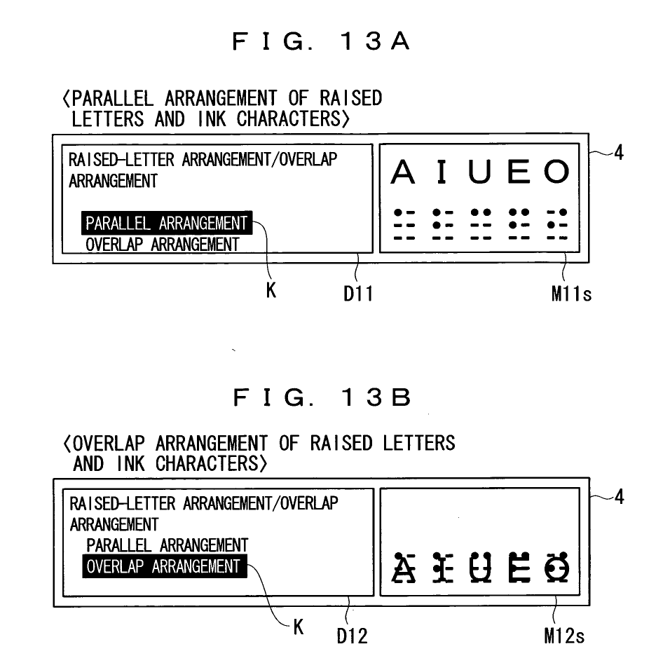

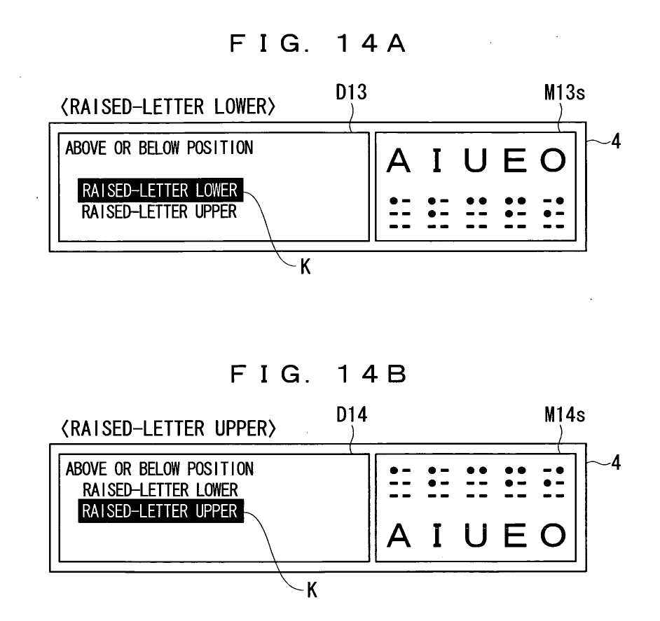

While only each of embossing points of raised letters on the monitor screen according to the foregoing embodiment is shown by a black circle and each of non-embossing points (points not to be embossed) is not indicated (see M11 to M14 in FIGS. 11A-12B), each non-embossing point may be indicated by, for example, a small square or a dash mark “-” so as to easily understand the overall screen (see M11s to M14s shown in FIGS. 13A-14B).

Also, while only a sample image is displayed on the occasion of the layout setting in the foregoing description, a preview image can be also displayed on the basis of the layout setting information after completion of the layout setting (i.e., in the state of D16 shown in FIG. 10A).

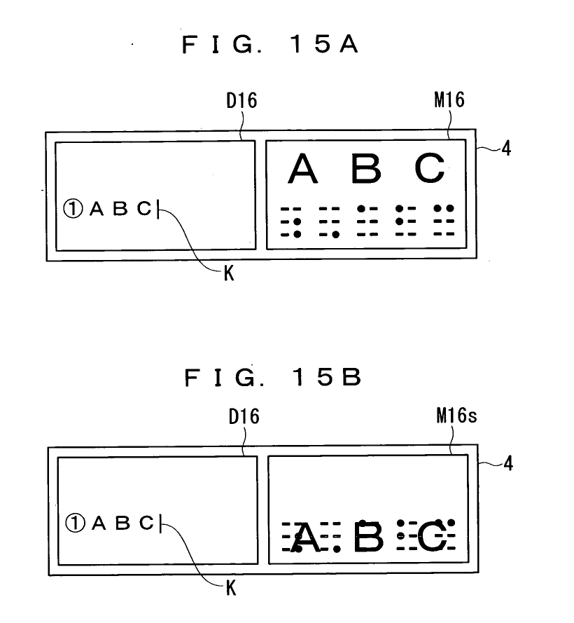

For example, in the case of the foregoing example, since the text edit screen (D16) returned as a typical display screen is in a state in which the character array “ABC” is inputted, and the parallel arrangement and the raised-letter lower are selected on the screen, when printing of ink characters and embossing of raised letters are carried out, raised letters corresponding to the ink characters “ABC” are embossed below the printed ink-character array “ABC”. With this structure, in the case of the foregoing example, as shown in FIG. 15A, a preview (M16) of an arrangement of the character array “ABC” and the corresponding raised letters arranged below the character array is displayed after completion of the layout setting (D16). Also, when the overlap arrangement is selected and set by way of example, another preview (M16s) is displayed as shown FIG. 15B.

In other words, since a sample image corresponding to a selected arbitrary alternative is displayed before the layout setting and a preview image on the basis of the set layout setting information is displayed after completion of the layout setting, an arbitrarily selected alternative can be confirmed with the corresponding sample image before the layout setting, and also its layout can be confirmed with the corresponding preview on the basis of actually inputted character information after the layout setting.

While a sample image and a preview image are formed on a tape T1 with a width of 24 mm, the label generating apparatus according to this invention is likewise applicable to a tape T2 with a width of 18 mm and a tape T3 with a width of 12 mm. In the case of the tapes T1 or T2, respectively having tape widths of 24 mm and 18 mm, after printing ink characters in a large size (for example, so as to meet the corresponding tape width), the corresponding raised letters can be partially overlaid with the upper or lower part of the printed ink characters (respectively corresponding to the raised-letter upper or the raised-letter lower) by selecting the overlap arrangement. While the relative relationship between ink characters and raised letters is described from the view point of only the above-and-below positional relationship, the label generating apparatus is also applicable to an arrangement of the front-and-rear relationship between ink characters and raised letters, according to which these two types of characters are arranged on a so-called common line. In addition, the label generating apparatus is also applicable to other arrangements of, for example, the above-and-below positional relationship according to which these two types of characters are arranged on mutually different lines among a plurality of lines and the oblique relative positional relationship according which the one type of characters are shifted in the vertical direction and partially overlapped with the other type of characters.

Functions or a variety of processing methods (including the character-information processing method) of the character-information processing apparatus according to the foregoing embodiment are applicable not only to the foregoing label-generating apparatus 1 but also to a storage medium such as a CD, an MD, and a DVD, storing such a program in the form of a program processed by a variety of program-processable apparatuses. Hence, by storing such a program, or by reading it from the storage medium or the like and executing it, a layout can be determined by easily and effectively operating the processing apparatus without having its instruction manual or the like at hand so as to refer it, whereby printing of ink characters and embossing of raised letters are easily carried out. It is taken for granted that a modification or a change of this invention is possible if needed within the scope of the spirit of this invention.

What is claimed is:

1. A character-information processing method comprising, upon selectively setting a layout among a plurality of alternatives, displaying on a display screen, sample images of the plurality of alternatives set for printing an ink character and embossing a raised letter on a common process sheet.

2. The method according to claim 1, wherein the plurality of alternatives include: a parallel arrangement of ink character and raised letter for arranging the raised letter and the ink character parallel to each other; and an overlap arrangement of ink character and raised letter for overlapping at least a part of the raised letter and ink character with each other.

3. The method according to claim 2, wherein the parallel arrangement of ink character and raised letter includes a raised-letter upper-and a raised-letter lower for arranging the raised letter above and below the ink character, respectively.

4. The method according to claim 1, further comprising the step of displaying a preview image in place of the corresponding sample image, on the basis of set layout information after selectively setting the layout.

5. A character-information processing apparatus for printing an ink character and embossing a raised letter on a common process sheet, comprising:
layout-alternative storage means for storing a plurality of alternatives of layouts set for arranging the raised letters and ink characters on the process sheet;
sample-image storage means for storing sample images of the plurality of alternatives; and
display means for displaying the sample images on a display screen, upon setting a layout selected among the plurality of alternatives.

6. The apparatus according to claim 5, wherein the display means displays a preview image in place of the corresponding sample image on the basis of set layout information after selectively setting the layout.

7. A program which causes the character-information processing method according to any one of claims 1 to 4 to be performed.

8. A storage medium which stores the program according to claim 7 so as to be readable with a program-processable apparatus.
